(19) United States
(12) Patent Application Publication
(10) Pub. No.: US 2003/0231398 A1
(43) Pub. Date: Dec. 18, 2003

(54) Side-mirror glare reduction device for trucks, truck cabs and sports utility vehicles

(76) Inventor: Christopher C. Cutaia, Boonton, NJ (US)

Correspondence Address: Ernest D. Buff, Ernest D. Buff & Associates, LLC, 245 South Street, Morristown, NJ, 07960, US

(21) Appl. No.: 10/172,676

(22) Filed: Jun. 17, 2002

(51) Int. Cl. G02B 27/00; G02B 5/08; G02B 17/00

(52) U.S. Cl. 359/608; 359/601; 359/604

(57) ABSTRACT

A liquid crystal cell is interposed between a vehicle driver and at least one of the vehicle's side view mirrors. It resides within the cabin of the vehicle and is warmed by the vehicle's interior. The cell is placed over the windowpane to dim headlight beams impinging on the driver and minimize eye discomfort. The liquid crystal cell operating temperature is maintained by cabin heating. Means are provided to detachably mount the liquid crystal cell over the windowpane. The liquid crystal cell can be dimmed manually dimmed or dimmed automatically in response to a sensor located in a position, which views the headlight directly or through a reflection. This liquid crystal cell dimming device affords a greater than 90 percentile reflection, and glare reduction for trucks, truck cabs and sport utility vehicles.

### BACKGROUND OF THE INVENTION

1. Field of the Invention

The present invention relates to reduction of glare produced by reflective media, such as side mirrors for land vehicles; and more particularly to an infinitely variable automatic or manual, glare reducing device especially suited for use with side mirrors of a truck cab, sports utility vehicle and the like.

2. Description of the Prior Art

Rear view mirrors located on the exterior of land vehicles, typically adjacent to the passenger and driver compartment, have long been used. These mirrors perform a valuable safety function by providing information to the vehicle driver concerning the whereabouts of other moving vehicles, as well as pedestrians and stationary structures behind of the vehicle. Such information, carried by light reflected from side mirrors, is frequently obscured by the intensity of the reflected light from headlights of vehicles directly behind.

Attempts to improve the information carrying capacity of rear view mirrors have lead to disclosure of various glare reduction mechanisms. U.S. Pat. No. 4,371,235 to Locke Sr. discloses an image control mirror having a second reflection surface to reduce glare; but requires frequent adjustment to set the reflection from headlights of vehicles directly behind in the second reflection mode. U.S. Pat. No. 4,560,260 to Russell discloses a side view mirror housing, secured for pivoting by a manually actuated sheathed cable to adjust its position for day/ night dimming. No provision is made for automatic dimming in both the Lock, Sr. device and Russell's device and they must to be manually adjusted to achieve the dimming function, which mechanically changes the location of the mirror to align the second reflection into the view of the driver. U.S. Pat. Nos. 5,668,663 and 5,724,187 to Varaprasad et al., disclose electrochromic rear view mirrors for motor vehicles. Electrochromic oxide having a thickness of a few microns is sandwiched between two conducting electrodes, which inject alkali ions or protons. A redox reaction created in the conducting electrochomic oxide provides the dimming action when voltage is applied. The mirror has a sensor, which provides input for the applied dimming voltage to control the response. The device physically darkens the mirror surface resulting in a darker image. No disclosure is contained therein concerning use of the sensor to detect glare.

Electrochromic mirrors are constructed using a first substantially transparent substrate having a substantially transparent conductive electrode coating on its inward surface. A second substrate, which may or may not be substantially transparent, has a conductive electrode coating, which also may or may not be substantially transparent, on its inward surface. Electrochromic oxide material is placed in between the two sheets. Whether the second substrate and the conductive electrode coating thereon are or are not substantially transparent will depend on the particular construction of the mirror. When the mirror is not dimmed its transmission capability is approximately 70%. This level of transmission fails to provide a clear view. No discussion is contained by the Varaprasad et al. patents concerning the thermal characteristics of the electrochromic mirror. It is probable that that mobility of the ions under the applied voltage, and hence the dimming action of their mirror, is a function of temperature. Yet, the Varaprasad et al. mirror contains no means for stabilizing the operating temperature. Moreover, the electrochtomic “dimming capacity” is deteriorated by ultraviolet radiation. For this reason, the Varaprasad et al. patent discloses use of glass material as well as additives, which absorb the ultraviolet radiation.

U.S. Pat. Nos. 4,848,875, 4,893,902, 4,899,503, 4,964,251, 5,009,044, 5,025,602, 5,111,629, 5,152,111, 5,197,242 to Baughman, et al. disclose a dual-pane thermal window unit that comprises two nonintersecting or, preferably, substantially parallel, spaced window panes, mounted in a window frame, a first of the panes having affixed thereto a first wall of an electro-optical liquid crystal cell providing a selected light transmittance, and a second of said panes delimiting, with a second wall of said cell, a space providing a thermal break. Each of the first and second walls comprises an electrically conductive film composed of plastic and having sufficient supporting strength to maintain the structural integrity of the cell. The window is lightweight, economical to manufacture and efficient and reliable in operation. To enhance the thermal barrier effect, space between the liquid crystal cell and the second pane may be evacuated to the extent practical, or filled with an inert gas selected from the group consisting of argon, nitrogen, dry air neon and mixtures thereof. Use of an inert gas, such as nitrogen, inside of the thermal pane can be usefully employed to prevent oxidative degradation of the liquid crystal medium. The Baughman et al. patents disclose a window embodiment wherein a first of the panes has affixed thereto a first wall of an electro-optical liquid crystal cell providing a selected light transmittance. Furthermore, the Baughman, et al. patents do not disclose use of a sensor responsive to glare from vehicle headlight beams impinging on the driver of a vehicle. The sensor response is used to vary the electrical conductivity of the liquid crystal film to change the opacity of the cell inversely with the strength of the impinging sunlight. Heat loss within the window system is addressed by insulating the second pane. The temperature of the liquid crystal element is maintained within the operating range by virtue of heat leakage from the house through the first pane.

Land vehicles rely primarily on the presence of side view mirrors to assess traffic flow, due to their extended length. Side view mirrors utilized with such vehicles are located laterally outward of the cab, at distance which increases directly with the vehicle's length, making them difficult to reach and adjust during driving. They are oriented to reflect light produced by objects directly behind the vehicle. Light from impinging headlight beams is focused directly at the driver, causing extreme eye discomfort and glare. Conventional side view mirrors must be manually adjusted or utilize electrochromic dimming mirrors, which fail to provide a clear rear view owing to their limited (˜70%) reflectance capability in the undimmed state. Liquid crystal dimming elements have never been seriously considered for use as darkening devices for reducing glare from side rear view mirrors due to the difficulty in maintaining the temperature of the liquid crystal cell within the narrow operating range. The limited temperature response of liquid crystal dimming elements requires that they be guarded from temperature variations.

There remains a need in the art for a reducing glare from side view mirror that can be located within the access of the driver to provide improved rear visibility, and preferably automatically adjust the dimming level to reduce glare caused by the impinging light beams from vehicle headlights. Also needed is a dimming device in the line of sight to the side view mirror that provides a clear image when glare-producing conditions are absent, notwithstanding temperature changes produced by rapid movement of the vehicle, or fluctuation of ambient temperature due to climatic change.

### SUMMARY OF THE INVENTION

Our present invention provides a high response liquid crystal cell, which is detachably mounted next to the glass windowpane in the path of the reflected image of headlight beams from side view mirrors. The liquid cell is maintained within its operating range due to heat applied within the cabin and is guarded from wind currents due to the glass windowpane. The voltage applied to dim the liquid crystal element can be either manually set by rotating a control knob or controlled automatically in response to a sensor which is in the path of the reflected light or directly views headlight beams rear of the vehicle.

The liquid crystal cell is placed next to the glass windowpane of the driver and passenger sides of a vehicle using slotted inserts and quick snaps or other clamping means including vacuum cups. The liquid crystal cell is thus positioned in the path of the reflected light from the side view mirrors, intersecting the glare producing headlight beams from vehicles behind. The temperature of the liquid crystal cell is maintained within the operating range due to heat provided within the cabin. The comfort zone of temperature needed for humans matches closely the temperature requirement for liquid crystal cells and the glass windowpane isolates the liquid crystal cell from wind currents due to vehicle motion and exterior weather conditions. When the liquid crystal elements are not activated, the cell is essentially clear, providing greater than 90-percentile reflection. During dimming of the liquid crystal elements in accordance with the sensor response or manual control, glare from impinging headlight beams is reduced due to the dimming action of the liquid crystal cell. The voltage application terminals for dimming the liquid crystal cell are provided and connected to manually adjustable voltage control electronics or automatic control electronics to set he dimness of the liquid crystal cell to the comfort level needed by the driver. Turning a easily accessible single knob in manual control without having to adjust the inaccessible side view mirrors provides a simple, easy and effective means to alleviate the glare problem. In the automatic mode, a sensor is adjustably incorporated between the liquid crystal cell and the windowpane at a location, which intersects the reflection of the headlight beam from the side view mirror and applies the required voltage to dim the liquid crystal cell. In one of the embodiments, the location of the sensor is adjustable to position remotely viewing the headlight beams of vehicles behind. These positions of the sensor preclude dimming of the liquid crystal cell in daylight since no harsh headlight beam is incident at the sensor location.

Broadly stated, the invention provides a dimming device for headlight beams from side rear-view mirrors for use in trucks, truck cabs and sports utility vehicles, comprising a liquid crystal cell, which dims in response to an applied voltage provided by a single control knob or a sensor generated voltage. The liquid crystal cell is positioned within the cabin between the side view mirror and the driver intercepting the reflected headlight from following vehicles. The warming of the cabin by using the cabin heaters accommodates the temperature control requirement of the liquid crystal cell and the glass windowpane protects the liquid crystal cell from weather and convection heat loss due to high velocity airflow. This placement of the liquid crystal cell behind the windowpane also protects it from condensation of water particles during fog, accumulation of ice or snow. Since the liquid crystal cell needs to cover only the region of the headlight reflected from the side view mirrors, it need not occupy the entire height and width of the glass windowpane. Adjusting the voltage applied to the liquid crystal cell can manually control the dimming of the liquid crystal cell. When no voltage is applied to the liquid crystal cell, the cell is clear with greater than 90% transparency. When voltage is applied the liquid crystal cell dims uniformly without optical distortion due to parallelism of the glass sheets defining the liquid crystal cell and the applied voltage controls the degree of darkness. Alternatively, a sensor may be used and is bathed in the headlight, which is reflected by the side view mirror or is directly made to view the headlights from following vehicles by proper sensor placement. Positions for this remote placement may include rear side of driver head rest or any portion in the rear of the vehicle, which faces the headlight beams from vehicles that are behind. The sensor element may be in the form of a photovoltaic device where the current from the sensor is proportional to the intensity of the impinging headlight radiation or a photo resistive device wherein the resistance is decreased by the intensity of headlight radiation. A PID control circuit to generate the needed voltage for dimming the liquid crystal cell processes the signal from the sensor.

### BRIEF DESCRIPTION OF DRAWINGS

The invention will be more fully understood and further advantages will become apparent when reference is had to the following detailed description and the accompanying drawings, in which:

FIG. 1 is a perspective view of a glare reduction device inserted between the side-view mirror and the driver within the cabin over the glass windowpane of the present invention, the figure showing the side view reflective elements, liquid crystal dimming elements, glass windowpanes, cabin heating means and sensor for automatic dimming the liquid crystal element;

FIG. 2 is a perspective view depicting a liquid crystal cell 25 of FIG. 1 having two sheets made from glass or polymeric material with transparent electrodes and liquid crystal in between.

FIG. 3 is a perspective view depicting attachment of a liquid crystal cell 25 of FIGS. 1 and 2 to window glass pane using stabilization slots and quick snaps;

FIG. 4 is a schematic diagram depicting the automatic control circuit for dimming control of the liquid crystal cell.

FIG. 5 is a schematic diagram depicting the manual control circuit for dimming control of the liquid crystal cell.

### DESCRIPTION OF THE PREFERRED EMBODIMENTS

The present invention provides manual or automatic glare reduction from headlight beams reflected by side-mirrors for trucks, truck cabs and sports utility vehicles having a construction that advantageously provides continuous dimming ability depending on the glare present and has the ability to become brighter as the glare is removed.

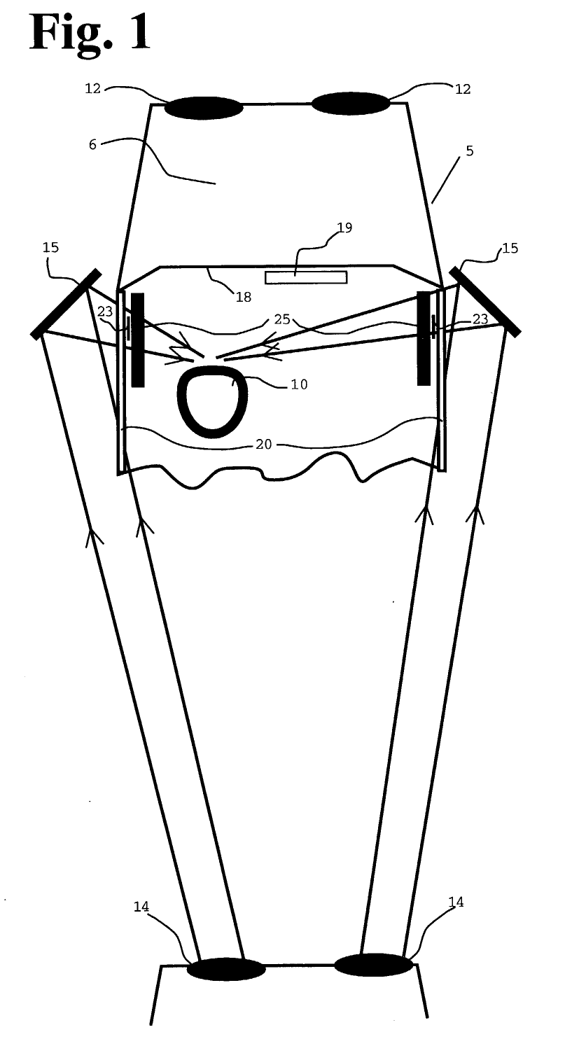

In FIG. 1 there is shown a perspective view of the glare reduction device interposed between the side mirror and the driver constructed according to the subject invention as shown in 5. The driver 10 in a vehicle marked 6 has the two side view mirrors located at 15. The vehicle's headlights are shown at 12. These side view mirrors reflect headlight beams from following vehicles as from 14 to the face of the driver at 10. The reflected light passes through the glass windowpane marked 20 and through the liquid crystal cell marked 25. Heaters located at 19 heat the cabin. The side view mirrors are is generally 16″ tall by 7″ wide and can reflect substantial amount of headlight to the face of the driver at 10, causing severe eye discomfort and blinding vision capability in the absence of the dimming element of the subject invention.

The intensity-determining sensor is located at 23. This sensor is placed between the glass windowpane and the liquid crystal cell and is directly above or below the line of sight of the headlight to the driver. Since the side view mirror is large enough, typically 16″ tall by 7″ wide, the reflected headlight beam bathes the sensor even when it is placed one to two inches above or below the driver's line of sight through the side view mirror to the headlights of the following vehicle. The reflected light from the side view mirror is shown as 33 in FIG. 3. The location of the sensor 23 is adjusted to bathe it in the reflected headlight beam. This sensor at 23 may be a photovoltaic device or a photo resistive device, and senses the intensity of light striking the driver, thus adjusting the dimming level of liquid crystal cell using the automatic control. This location of the sensor is such that daylight does not dim the mirror, so that a clear view is available during daytime. Alternatively, sensor can be located in a position which views the headlight of the following vehicles instead of being bathed in the reflection. Locations of this nature include backside of driver's head rest, any location outside the vehicle in the rear of the vehicle etc.

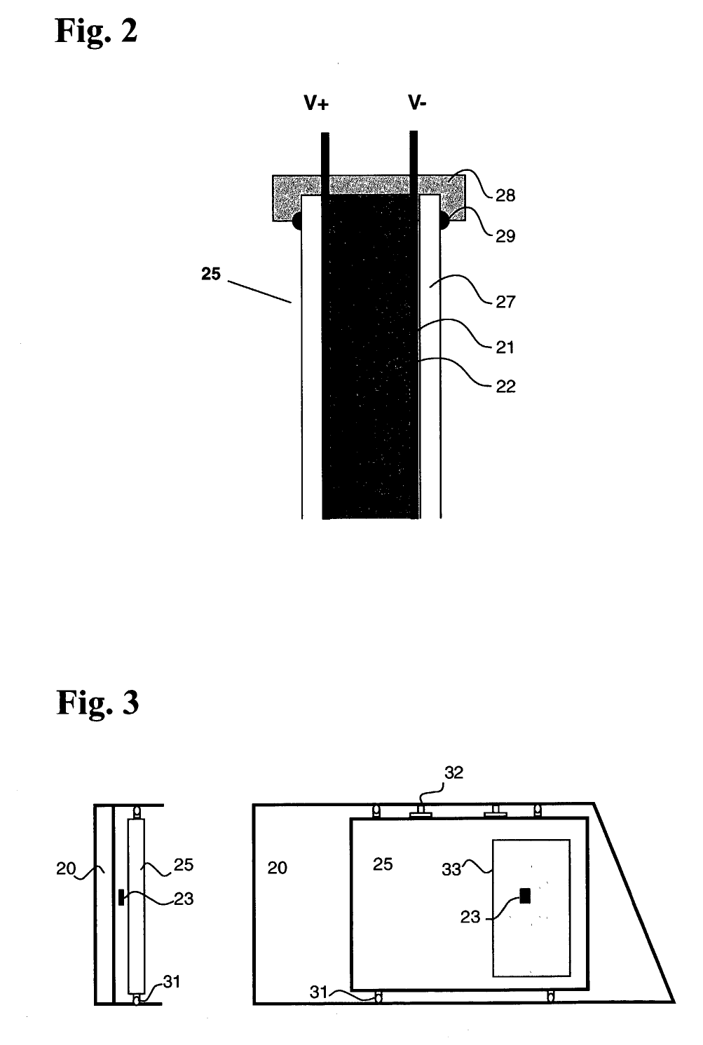

Referring to FIG. 2 of the drawings, there is shown a liquid crystal cell used in the invention. Liquid crystal cell 25 has two electrically conductive but transparent layers 21, such as indium tin oxide, which may be formed by coating a transparent glass or polymer sheet marked 27. The thickness of the electro-optic liquid crystal layer 22 is typically 1 mil (1/1000 of an inch). It requires a critical voltage of 2 to 20 volts per mil, where the critical current flow disrupts the uniform alignment of the liquid crystal, causing dynamic scattering or change in pitch of helical liquid crystals or change in the orientation of dichroic dye molecules dissolved in the liquid crystal. These effects decrease the transmission of the light, creating dimming of the liquid crystal layer in response to the applied voltage applied at V+/N−. Liquid crystals can be used in different modes to reduce the transmission of light. These modes include (1) dynamic light scattering from turbulent flow of liquid crystals in an applied electric field; and (2) changes in light absorption as a consequence of application of electric field. The first effect produces grainy darkening, while the second effect, which is preferred, produces gradual uniform darkening. In the second method, one uses liquid crystals which are cholesteric and have helical structure, the pitch of which is changed by the application of an electric field. Also, orientation of monomeric or polymeric dye molecules incorporated in a liquid crystal can change the orientation of the dye molecule depending upon the applied voltage, providing dimming capability. The DC low voltage needed is applied by rectifying an AC voltage, and the applied voltage controls the degree of dimming of the liquid crystal. The edges of the liquid crystal cell is capped as shown in FIG. 2 at 28 and the conductive electrode coated glass or polymeric sheet is sealed against the cap by a flexible bead such as butyl rubber or silicone as shown at 29. The liquid crystals have to be maintained within a few degrees for proper operation and placing the liquid crystal cell within the heated cabin meets this thermal requirement.

Referring to FIG. 3 of the drawings, there is shown a liquid crystal cell, which is detachably mounted on the windowpane. The windowpane is shown at 20. The liquid crystal cell 25 is mounted using quick snaps 31 and stabilization slots 32. The stabilization slots are present on top only to assure that the liquid crystal cell is held firmly. Alternatively, the liquid crystal cell can be mounted vacuum suction cups made from polymeric material. The sensor 23, which is mounted in between the windowpane and the liquid crystal cell in the path of reflected headlight for automatic control of liquid crystal cell, is also shown. The region of area where the headlight reflection is projected on the liquid crystal cell by the side view mirror is shown at 33 and the sensor 23 is placed within this area.

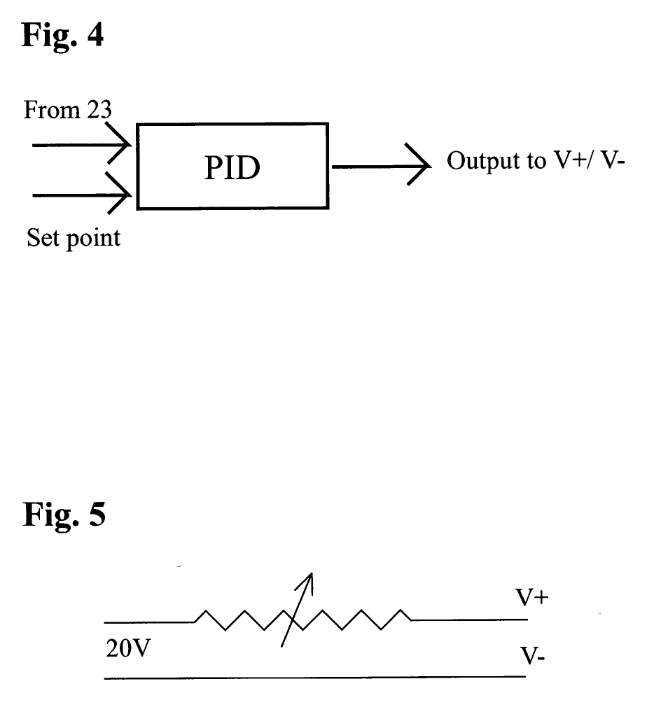

FIG. 4 shows a typical control circuit for adjusting the dimming of the liquid crystals cell. The intensity of the headlight beam is measured as a current in the case of a photovoltaic sensor 23 or as a voltage drop across a photo resistor sensor 23 and is provided as an input for the control logic, which includes proportional, integrating and differential controller (PID). The set point for the temperature is internally set as a memory number in the processor, and the output is computed based on the gain, reset and derivative values. The output of the control logic is sent as a voltage V+/V− to control the dimming of the liquid crystal cell.

In FIG. 5 there is shown a schematic diagram of a manual control device for dimming the liquid crystal cell. The manual control device has a variable resistance, which changes the voltage V+/V− applied to dim the liquid crystal cell. The DC voltage from the alternator or the battery converted to produce 20 volts and is attenuated using a variable resistor or a regulator chip to provide voltages in the range of 2 to 20 to provide the desired dimming effect.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A side mirror glare reduction system for a land vehicle, comprising:
a. a set of side view mirrors;
b. a liquid crystal light dimming cell disposed adjacent to a windowpane within a cabin of said vehicle in the path of reflected headlight from at least one of said side view mirrors;
c. dimming means electrically connected to said liquid crystal cell for applying dimming voltage to liquid crystals therewithin;
d. heating means for maintaining the temperature of said liquid crystal cell using ambient heat from said cabin; and
e. control means for adjusting the dimness of said liquid crystal cell inversely with said headlight brightness intensity.

2. A side mirror glare reduction system as recited by claim 1, wherein said dimming means comprises at least one sensor and an automatic dimming control circuit.

3. A side mirror glare reduction system as recited by claim 1, wherein said dimming means comprises a manual circuit for applying required dimming voltage to said liquid crystal cell.

4. A side mirror glare reduction system as recited by claim 1, wherein said liquid crystal cell is detachably connected to said window pane using stabilization slots and quick snaps.

5. A side mirror glare reduction system as recited by claim 1, wherein said liquid crystal cell is detachably connected to said window pane using vacuum mounting cups.

6. A side mirror glare reduction system as recited by claim 2, wherein said sensor is mounted between the windowpane and the liquid crystal cell in the path of the reflected headlight.

7. A side mirror glare reduction system as recited by claim 2, wherein said sensor is detachably mounted for directly viewing a following vehicle headlight.

8. A side mirror glare reduction system for a land vehicle, comprising a liquid crystal cell that is capable of being dimmed, and is interposed between a side rear-view mirror of a vehicle and a driver thereof, said cell being positioned within a cabin of the vehicle, so as to be detachably connected to a windowpane for reducing the intensity of headlight brightness, and including:
a. a set of side view mirrors;
b. said liquid crystal cell being disposed adjacent to said windowpane within said cabin in the path of reflected headlight from at least one of said side view mirrors;
c. dimming means electrically connected to said liquid crystal cell for applying dimming voltage to liquid crystals therewithin;
d. heating means for maintaining the temperature of said liquid crystal cell using ambient heat from said cabin; and
e. control means for adjusting the dimness of said liquid crystal cell inversely with said headlight brightness intensity.
